(19) United States
(12) Patent Application Publication
(10) Pub. No.: US 2014/0043202 A1
(43) Pub. Date: Feb. 13, 2014

(54) COMMUNICATION DEVICE AND ANTENNA SYSTEM THEREIN

(71) Applicant: ACER INCORPORATED, Hsichih (TW)

(72) Inventors: Kin-Lu WONG, Hsichih (TW); Huan-Jyun JIANG, Hsichih (TW)

(73) Assignee: ACER INCORPORATED, Hsichih (TW)

(21) Appl. No.: 13/764,344

(22) Filed: Feb. 11, 2013

(30) Foreign Application Priority Data
Aug. 9, 2012 (TW) 101128726

(51) Int. Cl. H01Q 21/28; H01Q 5/00

(52) U.S. Cl. CPC H01Q 21/28; H01Q 5/001
USPC 343/848

(57) ABSTRACT

A communication device including a first conductive plate and an antenna system is provided. The antenna system includes a first antenna, a second antenna, a ground plane, and an open slot. Both the first antenna and the second antenna operate in at least a first band and a second band. The ground plane substantially has an inverted-T shape, and includes a main ground plane and a protruded ground plane. The main ground plane is coupled to the first conductive plate. The protruded ground plane is substantially located between the first antenna and the second antenna. The open slot is formed on the ground plane, and an open end of the open slot is located at an edge of the protruded ground plane. The open slot increases the isolation between the first antenna and the second antenna in the first band and the second band.

### CROSS REFERENCE TO RELATED APPLICATIONS

This Application claims priority of Taiwan Patent Application No. 101128726 filed on August 9, the entirety of which is incorporated by reference herein.

### BACKGROUND OF THE INVENTION

1. Field of the Invention

The disclosure generally relates to a communication device, and more particularly, relates to a communication device comprising a MIMO (Multi-Input Multi-Output) multi-band antenna system with high isolation.

2. Description of the Related Art

As people demand more and more signal transmissions and transmission rates thereof, relative communication standards support higher and higher data transmission rates. A system with multiple antennas is required to be capable of receiving and transmitting signals at the same time. For example, the communication standard of IEEE 802.11n for WLAN (Wireless Local Area Network) can support a MIMO operation to increase transmission rate. As a matter of fact, it is a future trend to use multiple antennas in a mobile device. Since multiple antennas should be disposed in a limited space of a mobile device, these antennas are very close to each other and result in serious interference. Keeping high isolation between these antennas seems to be a critical challenge for a designer.

Traditionally, the method for improving isolation and for reducing mutual coupling in a system with multiple antennas is performed by disposing a parasitic isolation metal element between two adjacent antennas, wherein the resonant frequency of the parasitic isolation metal element is very close to that of the antennas to reject current coupling between the antennas, thereby increasing the isolation between the antennas. However, such a method usually leads to decreased radiation efficiency and degraded radiation performance due to the parasitic isolation metal element, which acts as a radiator as well. In addition, the parasitic isolation metal element traditionally causes high isolation merely for a single band, but cannot cause high isolation in multiple bands.

Accordingly, there is a need to design a new communication device comprising a multi-band antenna system, which not only has high isolation between antennas therein in multiple bands but also maintains good radiation efficiency.

### BRIEF SUMMARY OF THE INVENTION

The invention is aimed to provide a communication device comprising an antenna system. The antenna system comprises at least two multi-band antennas and an isolation element. The antennas have high isolation therebetween in multiple bands, and the antenna system has good radiation efficiency.

In a preferred embodiment, the disclosure is directed to a communication device, comprising: a first conductive plate; and an antenna system, being substantially a planar structure, wherein the antenna system at least comprises: a first antenna, operating in at least a first band and a second band, wherein the first band is lower than the second band; a second antenna, operating in at least the first band and the second band; a ground plane, comprising a main ground plane and a protruded ground plane, wherein the main ground plane and the protruded ground plane substantially forms an inverted-T shape, the protruded ground plane is substantially located between the first antenna and the second antenna, and the main ground plane is coupled to the first conductive plate; and an open slot, formed on the ground plane, wherein an open end of the open slot is located at an edge of the protruded ground plane, and the open slot increases isolation between the first antenna and the second antenna in the first band and the second band.

In some embodiments, the antenna system is substantially located at a first edge of the first conductive plate, and at least a portion of the open slot is located on the main ground plane.

In some embodiments, the open slot of the antenna system has a spiral shape, or at least a portion of the open slot has a meandering shape. The open slot can resonate in both the first band and the second band so as to attract surface currents on the ground plane, thereby reducing the current coupling between the antennas. Accordingly, the antenna system of the invention not only has high isolation in multiple bands but also maintains good radiation efficiency.

In some embodiments, the isolation (S21) of the antenna system of the invention is lower than about −20 dB in the first band (e.g., a WLAN (Wireless Local Area Network) 2.4 GHz band). In addition, the isolation (S21) of the antenna system of the invention is lower than about −25 dB in the second band (e.g., a WLAN 5.2/5.8 GHz band).

### BRIEF DESCRIPTION OF DRAWINGS

The invention can be more fully understood by reading the subsequent detailed description and examples with references made to the accompanying drawings, wherein:

FIG. 1A is a diagram for illustrating a communication device according to a first embodiment of the invention;

FIG. 1B is a diagram for illustrating a communication device according to a second embodiment of the invention;

FIG. 2 is a diagram for illustrating an antenna system according to an embodiment of the invention;

FIG. 3A is a diagram for illustrating S parameters of the antenna system shown in FIG. 2 according to an embodiment of the invention;

FIG. 3B is a diagram for illustrating S parameters of the antenna system without any open slot according to an embodiment;

FIG. 4 is a diagram for illustrating an antenna system according to another embodiment of the invention;

FIG. 5 is a diagram for illustrating an antenna system according to an embodiment of the invention; and

FIG. 6 is a diagram for illustrating an antenna system according to an embodiment of the invention.

### DETAILED DESCRIPTION OF THE INVENTION

In order to illustrate the foregoing and other purposes, features and advantages of the invention, the embodiments and figures thereof in the invention are shown in detail as follows.

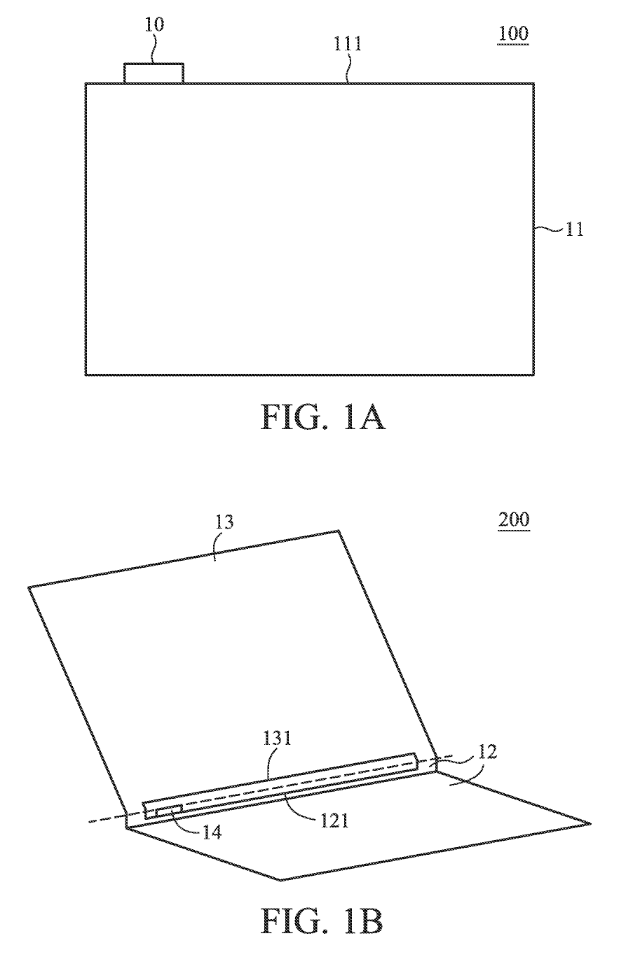

Refer to FIG. 1A and FIG. 1B together. FIG. 1A is a diagram for illustrating a communication device 100 according to a first embodiment of the invention. In the first embodiment, the communication device 100 comprises an antenna system 10 and a first conductive plate 11. The first conductive plate 11 may be a supporting conductive plate of a tablet computer. The antenna system 10 is substantially located at a first edge 111 of the first conductive plate 11. The antenna system 10 is substantially a planar structure. The antenna system 10 is located on a plane, which is substantially parallel to the first conductive plate 11 and extends away from the first conductive plate 11.

FIG. 1B is a diagram for illustrating a communication device 200 according to a second embodiment of the invention. In the second embodiment, the communication device 200 comprises a first conductive plate 12, a second conductive plate 13, and an antenna system 14. The first conductive plate 12 is electrically coupled to the second conductive plate 13. A second edge 131 of the second conductive plate 13 is close to a first edge 121 of the first conductive plate 12. In some embodiments, the second conductive plate 13 is a supporting conductive plate of an upper cover of a notebook computer. The antenna system 14 is substantially located between the first edge 121 of the first conductive plate 12 and the second edge 131 of the second conductive plate 13.

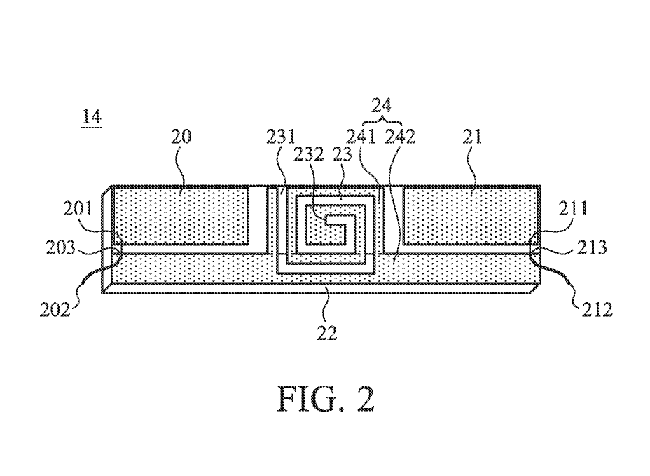

FIG. 2 is a diagram for illustrating an antenna system 14 according to an embodiment of the invention. In the embodiment, the antenna system 14 comprises at least a first antenna 20, a second antenna 21, a ground plane 24, and an open slot 23 of the ground plane 24. The ground plane 24 substantially has an inverted-T shape. The ground plane 24 comprises a protruded ground plane 241 and a main ground plane 242. The protruded ground plane 241 is substantially located between the first antenna 20 and the second antenna 21. The main ground plane 242 is electrically coupled to the first conductive plate 12. The antenna system 14 may be disposed on a dielectric substrate 22. The first antenna 20 operates in at least a first band and a second band, wherein the first band is lower than the second band. Similarly, the second antenna 21 also operates in at least the first band and the second band. The first antenna 20 comprises a positive feeding end 201 and a negative feeding end 203. The negative feeding end 203 is electrically coupled to the main ground plane 242, and the positive feeding end 201 is electrically coupled to a coaxial cable 202 so as to excite the first antenna 20. Similarly, the second antenna 21 also comprises a positive feeding end 211 and a negative feeding end 213. The negative feeding end 213 is electrically coupled to the main ground plane 242, and the positive feeding end 211 is electrically coupled to another coaxial cable 212 so as to excite the second antenna 21. The ground plane 24 further has the open slot 23. The length of the open slot 23 is approximately equal to 0.5 wavelength of the lowest frequency in the first band. In some embodiments, at least a portion of the open slot 23 is located on the main ground plane 242. An open end 231 of the open slot 23 is located at an edge of the protruded ground plane 241. In the embodiment, the open slot 23 substantially has a spiral shape. The open slot 23 of the ground plane 24 resonates in the first band and the second band so as to attract surface currents on the ground plane 24, thereby reducing the current coupling between the first antenna 20 and the second antenna 21. Accordingly, the open slot 23 increases the isolation between the first antenna 20 and the second antenna 21 in the first band and the second band. Note that the antenna system 14 may comprise more than three antennas in other embodiments although there are only two antennas shown in FIG. 2.

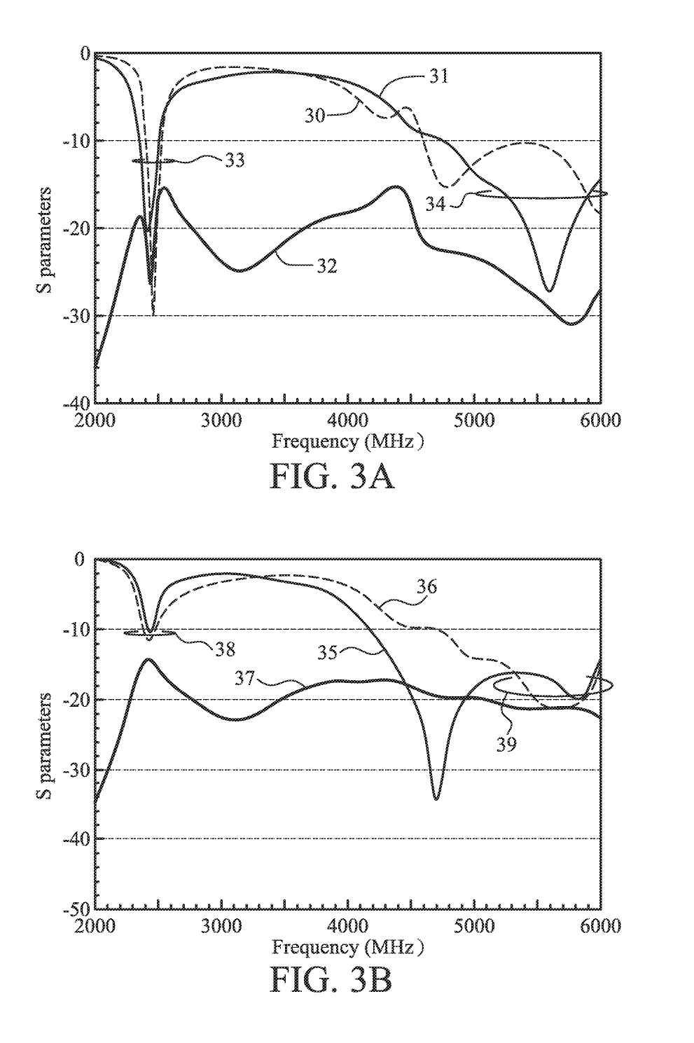

FIG. 3A is a diagram for illustrating S parameters of the antenna system 14 shown in FIG. 2 according to an embodiment of the invention. In an embodiment, the area of the antenna system 14 is approximately equal to 495 mm² (55 mm by 9 mm), and the area of the first conductive plate 12 is approximately equal to 52000 mm² (260 mm by 200 mm). According to the criterion of 10 dB return loss, the reflection coefficient (S11) curve 30 of the first antenna 20 and the reflection coefficient (S22) curve 31 of the second antenna 21 both comprise a first band 33 and a second band 34. In a preferred embodiment, the first band 33 may cover a WLAN (Wireless Local Area Network) 2.4 GHz band (about from 2400 MHz to 2484 MHz), and the second band 34 may cover WLAN 5.2/5.8 GHz bands (about from 5150 MHz to 5350 MHz and from 5725 MHz to 5875 MHz). When the antenna system 14 performs a MIMO (Multi-Input Multi-Output) operation in a WLAN system, the isolation (S21) curve 32 between the first antenna 20 and the second antenna 21 is from about −20 dB to −27 dB in the first band 33 and is from about −25 dB to −31 dB in the second band 34. The antenna efficiency (including the loss due to impedance matching) of the first antenna 20 is approximately from 60% to 70% and from 87% to 92% in the first band 33 and the second band 34, respectively. The antenna efficiency (including the loss due to impedance matching) of the second antenna 21 is approximately from 60% to 70% and from 93% to 97% in the first band 33 and the second band 34, respectively. Thus, the antenna system 14 of the invention has good radiation efficiency in both the first band 33 and the second band 34. Note the invention is not limited to the above. The foregoing frequency ranges and element sizes may be adjusted by a designer according to different demands.

FIG. 3B is a diagram for illustrating S parameters of the antenna system 14 without the open slot 23 according to an embodiment. According to the criterion of 10 dB return loss, the reflection coefficient (S11) curve 35 of the first antenna 20 and the reflection coefficient (S22) curve 36 of the second antenna 21 both also comprise a first band 38 and a second band 39. In comparison to FIG. 3A, if the antenna system 14 does not include any open slots, the isolation (S21) curve 37 between the first antenna 20 and the second antenna 21 will be merely about −15 dB in the first band 38 and about −20 dB in the second band 39. According to FIG. 3A and FIG. 3B, the open slot 23 of the ground plane 24 can effectively improve the isolation between the first antenna 20 and the second antenna 21 by at least 5 dB in the first band 33 and the second band 34.

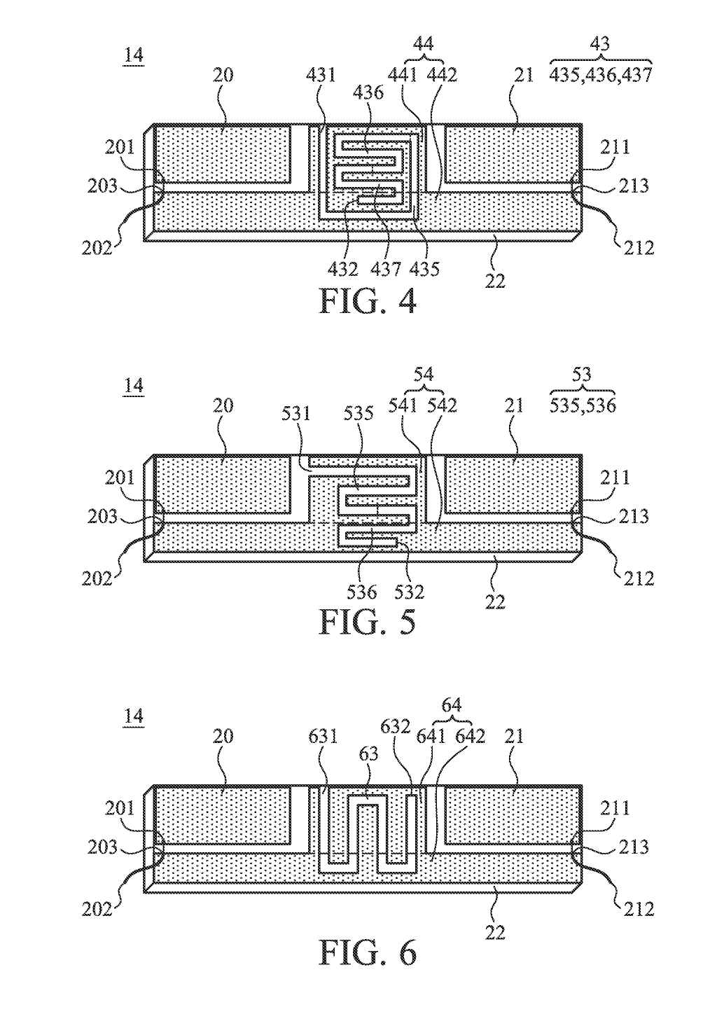

FIG. 4 is a diagram for illustrating an antenna system 14 according to another embodiment of the invention. FIG. 4 is substantially similar to FIG. 2. The difference between the two embodiments is that in FIG. 4, at least a portion of an open slot 43 of a ground plane 44 has a meandering shape. More particularly, the open slot 43 comprises a U-shaped portion 435, a first S-shaped portion 436, and a second S-shaped portion 437, wherein the first S-shaped portion 436 and the second S-shaped portion 437 are substantially surrounded by the U-shaped portion 435. In the embodiment, the open slot 43 with a specific shape can resonate in the first band 33 and the second band 34. Accordingly, the open slot 43 also increases the isolation between the first antenna 20 and the second antenna 21 in the first band 33 and the second band 34.

FIG. 5 is a diagram for illustrating an antenna system 14 according to an embodiment of the invention. FIG. 5 is substantially similar to FIG. 2. The difference between the two embodiments is that in FIG. 5, at least a portion of an open slot 53 of a ground plane 54 has a meandering shape. More particularly, the open slot 53 comprises a first inverted S-shaped portion 535 and a second inverted S-shaped portion 536. In the embodiment, the open slot 53 with a specific shape can resonate in the first band 33 and the second band 34. Accordingly, the open slot 53 also increases the isolation between the first antenna 20 and the second antenna 21 in the first band 33 and the second band 34.

FIG. 6 is a diagram for illustrating an antenna system 14 according to an embodiment of the invention. FIG. 6 is substantially similar to FIG. 2. The difference between the two embodiments is that in FIG. 6, at least a portion of an open slot 63 of a ground plane 64 has a meandering shape. More particularly, the open slot 63 substantially has a W-shape. In the embodiment, the open slot 63 with a specific shape can resonate in the first band 33 and the second band 34. Accordingly, the open slot 63 also increases the isolation between the first antenna 20 and the second antenna 21 in the first band 33 and the second band 34.

Note that a variety of antenna systems 14 as shown in FIGS. 2, 4, 5 and 6 may be applied to the communication devices 100 and 200 as shown in FIGS. 1A and 1B. In some embodiments, the communication device 100 is a smart phone or a tablet computer, and the communication device 200 is a notebook computer.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a first conductive plate; and
an antenna system, being substantially a planar structure, wherein the antenna system at least comprises:
a first antenna, operating in at least a first band and a second band, wherein the first band is lower than the second band;
a second antenna, operating in at least the first band and the second band;
a ground plane, comprising a main ground plane and a protruded ground plane, wherein the main ground plane and the protruded ground plane substantially forms an inverted-T shape, the protruded ground plane is substantially located between the first antenna and the second antenna, and the main ground plane is coupled to the first conductive plate; and
an open slot, formed on the ground plane, wherein an open end of the open slot is located at an edge of the protruded ground plane, and the open slot increases isolation between the first antenna and the second antenna in the first band and the second band.

2. The communication device as claimed in claim 1, wherein the antenna system is substantially located at a first edge of the first conductive plate.

3. The communication device as claimed in claim 1, wherein at least a portion of the open slot is located on the main ground plane.

4. The communication device as claimed in claim 1, wherein each of the first antenna and the second antenna comprises a positive feeding end and a negative feeding end, and the negative feeding ends are both coupled to the main ground plane.

5. The communication device as claimed in claim 1, wherein the antenna system is located on a plane which is substantially parallel to the first conductive plate and extends away from the first conductive plate.

6. The communication device as claimed in claim 1, wherein a length of the open slot is approximately equal to 0.5 wavelength of the lowest frequency in the first band.

7. The communication device as claimed in claim 1, wherein the open slot has a spiral shape.

8. The communication device as claimed in claim 1, wherein at least a portion of the open slot has a meandering shape.

9. The communication device as claimed in claim 8, wherein the open slot comprises a U-shaped portion, a first S-shaped portion, and a second S-shaped portion, wherein the first S-shaped portion and the second S-shaped portion are substantially surrounded by the U-shaped portion.

10. The communication device as claimed in claim 8, wherein the open slot comprises a first inverted S-shaped portion and a second inverted S-shaped portion.

11. The communication device as claimed in claim 8, wherein the open slot substantially has a W-shape.

12. The communication device as claimed in claim 1, further comprising:
a second conductive plate, coupled to the first conductive plate, wherein a second edge of the second conductive plate is close to a first edge of the first conductive plate, and the antenna system is substantially located between the first edge and the second edge.
